(19) United States
(12) Patent Application Publication
(10) Pub. No.: US 2023/0230491 A1
(43) Pub. Date: Jul. 20, 2023

(54) SKILL JOURNEY FEATURE AND LIVE ASSESSMENT TOOL ON A LEARNING PLATFORM

(71) Applicant: SHARELOOK PTE. LTD., Singapore (SG)

(72) Inventor: Raanan NEDIVI, Singapore (SG)

(21) Appl. No.: 18/100,577

(22) Filed: Jan. 24, 2023

Related U.S. Application Data
(63) Continuation-in-part of application No. 16/699,761, filed on Dec. 2, 2019.
Application No. 16/699,761 is a continuation of application No. 16/015,203, filed on Jun. 22, 2018, now Pat. No. 10,497,272.
Application No. 16/015,203 is a continuation-in-part of application No. 17/229,815, filed on Apr. 13, 2021.
Application No. 17/229,815 is a continuation-in-part of application No. 16/773,992, filed on Jan. 28, 2020, now Pat. No. 11,069,250.
Application No. 16/773,992 is a continuation-in-part of application No. 17/378,756, filed on Jul. 18, 2021.
Application No. 17/378,756 is a continuation of application No. 16/773,992, filed on Jan. 28, 2020, now Pat. No. 11,069,250.
(60) Provisional application No. 63/302,984, filed on Jan. 25, 2022.

(51) Int. Cl. G09B 5/02; H04L 65/403; G09B 5/06; H04W 4/06; H04L 51/046; H04L 67/50; H04W 4/08

(52) U.S. Cl. CPC G09B 5/02; H04L 65/403; G09B 5/06; H04W 4/06; H04L 51/046; H04L 67/535; H04W 4/08; G06F 3/0482

(57) ABSTRACT

A method and system comprising an adaptive learning platform having a backend component for managing 3D lessons for display on an interface of a user device. The platform facilitates in creating a Skills Journey with live assessment.

### CROSS-REFERENCE TO RELATED APPLICATION

This application claims the benefit of U.S. Provisional Application Ser. No. 63/302,984, filed on Jan. 25, 2022. This application is also a continuation-in-part of co-pending application U.S. patent application Ser. No. 16/699,761, filed on Dec. 2, 2019, which is a continuation of co-pending application U.S. patent application Ser. No. 16/015,203, now U.S. Pat. No. 10,497,272, filed on Jun. 22, 2018. This application is also a continuation-in-part of co-pending application U.S. patent application Ser. No. 17/229,815, filed on Apr. 13, 2021, which is a continuation-in-part of co-pending application U.S. patent application Ser. No. 16/773,992, now U.S. Pat. No. 11,069,250, filed on Jan. 28, 2020. This application is also a continuation-in-part of co-pending application U.S. patent application Ser. No. 17/378,756, filed on Jul. 18, 2021, which is a continuation of co-pending application U.S. patent application Ser. No. 16/773,992, now U.S. Pat. No. 11,069,250, filed on Jan. 28, 2020. All disclosures are herein incorporated by reference in their entireties for all purposes.

### FIELD OF THE INVENTION

The present invention is generally related to a networked platform for interactive learning. More specifically, the present invention is directed to an interactive virtual learning platform configured to rapidly create digital content in an intelligent and learning effective manner, including skills journeys by skills journeys builders for learning skills by learners with live assessment of learners by an assessor.

### BACKGROUND

The development and deployment of technological social networking systems and the possibility of instant reach to information, particularly in a wireless environment has changed the way people learn and communicate today. Furthermore, mobile devices have become ubiquitous in today's society. Many people use mobile devices such as personal digital assistants (PDAs), laptops, tablet devices or any smart device in their daily lives. The development of a networked and connected world has resulted in mushrooming of social networks, which grant end-users the opportunity to connect with others in ways not possible before. However, little has been done towards providing people with a virtual learning platform that encourages social interaction between end-users.

Accordingly, there is a need for a computer implemented method and system that provides a learning experience by combining interactive learning opportunities with social interaction to provide the learner with higher levels of interest and involvement during learning activities. In addition, the platform provides developers to easily develop skills journeys to help learners develop skills and to enable live assessment of performance by learners.

### SUMMARY

The Skill Journey is an innovative feature on a learning platform that helps organizations train and assess employees on specific skills using various resources, including courses, mazes, live events, and coaching sessions. The live assessment functions as a tool on the Skill Journey feature to enhance the quality of the Skill Journey feature.

### BRIEF DESCRIPTION OF THE DRAWINGS

FIG. 1a-h illustrates the steps to create a Skill Journey on the learning platform;

FIG. 2 illustrates the learning platform live assessment and the question tag to the video frame;

FIGS. 3a-d illustrates the steps to create Live Assessments;

### DETAILED DESCRIPTION

The primary purpose of the skill journey is to curate learning materials for specific skills for easier access by the learner and easy tracking by the trainer. Learners can swiftly navigate and access courses that are relevant to their professional goals. Instead of figuring out what materials they should use to attain specific skills, the journey is already well-curated for them by a subject expert. With a well-curated skill journey, learners can focus on essential materials and ignore irrelevant materials when pursuing a specific skill. The skill journey is also necessary for organizations and institutions in assessing skill competencies. The organization can track and evaluate whether learners have gone through all the required content and attained favourable scores. Also, organizations that have the need for a specific skill for temporary or permanent positions will be able to immediately locate who had already passed the requirements using skill journey. Skill journey can also be linked to a personality scenario based test and match the results of the skill journey to personality to achieve a better match to job skills. This can be done with or without an AI module.

When creating a Skill Journey for a specific skill on the learning platform, such as Sharelook, the author can include all the learning materials and assessments needed to attain the particular skills. For instance, when creating a Skill Journey for a Frontend web developer, the author can include learning materials for various skills such as HTML, CSS, JavaScript, React JS etc. The materials contained in a Skill Journey can include courses, SCORM courses, Mazes, Live Events, and live assessments. The various materials can be created utilizing the platform or conducted on the platform and recorded.

The materials, for example, may be stored in a datastore of the leaning platform or can be generated by the creator. For example, the materials may be created or conducted on the platform and stored, as described in U.S. patent application Ser. No. 16/015,203, now U.S. Pat. No. 10,497,272, filed on Jun. 22, 2018, which is already herein incorporated by reference for all purposes. For Mazes, they can be generated by the Maze creation module, as described in U.S. patent application Ser. No. 16/773,992, now U.S. Pat. No. 11,069,250, filed on Jan. 28, 2020, which is already herein incorporated by reference for all purposes. Furthermore, the materials may be split into smaller segments according to topics using an AI, as described in U.S. patent application Ser. No. 17/229,815, filed on Apr. 13, 2021, which is also already herein incorporated by reference for all purposes.

When a learner completes the Skill Journey, i.e., gone through all the materials, such as courses, mazes, or events, they are awarded a score based on their performance. The learner is also awarded a badge for completion of the Skill Journey and if they attain the minimum score to pass, they are given a certificate for that particular skill.

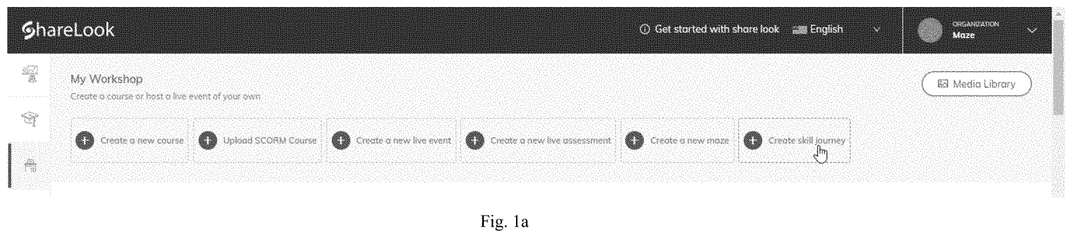

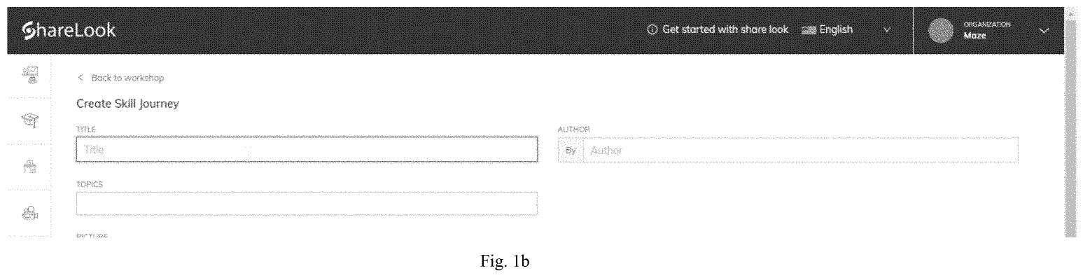

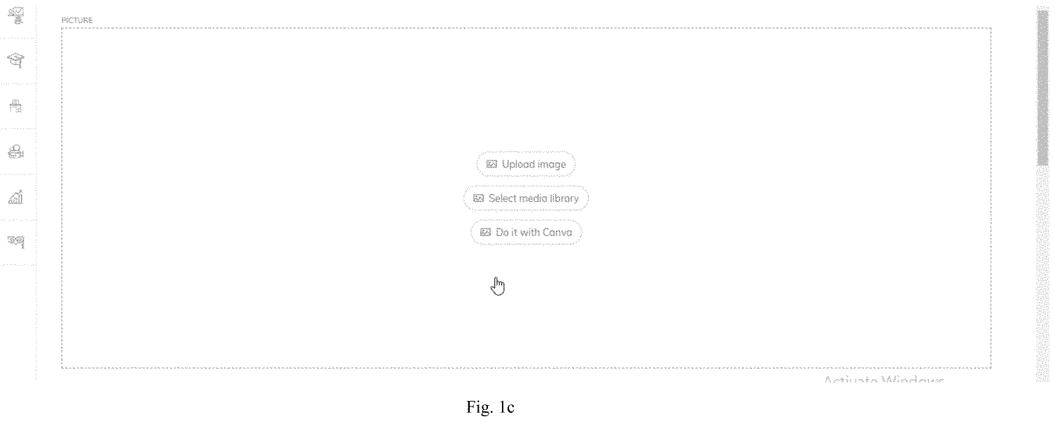

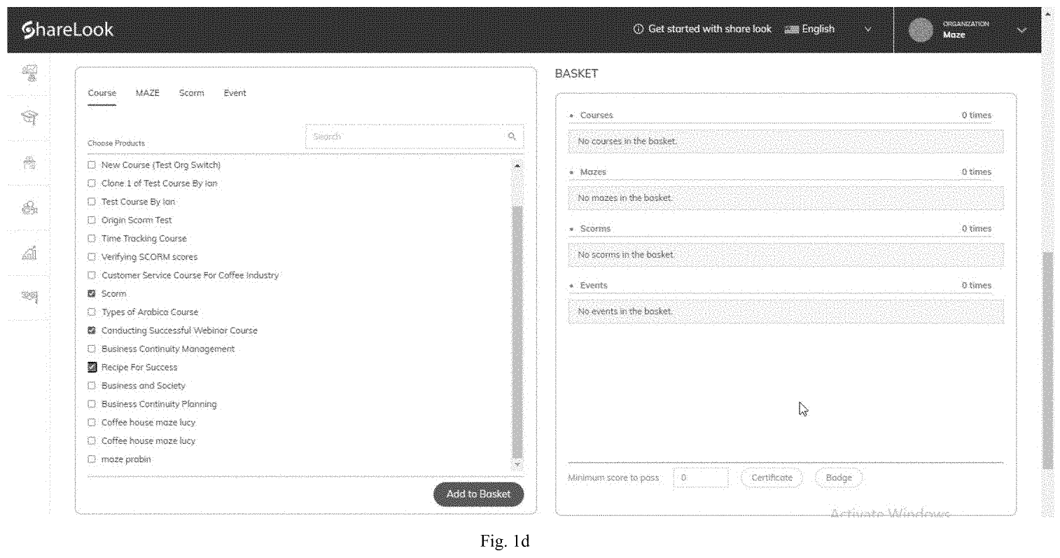

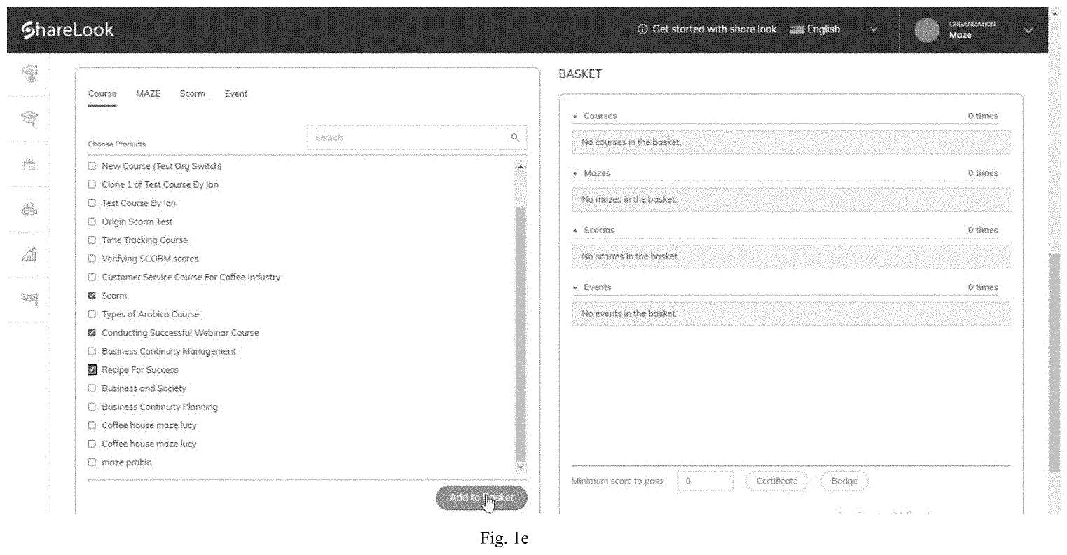

FIG. 1a-f shows various screenshots of the learning platform and serves as a guide to create a Skill Journey. In FIG. 1a, the author will begin by clicking on ‘My Workshop’ on the left panel of the learning platform's homepage followed by clicking on the tab ‘Create skill journey’ on top of the ‘My Workshop’ page.

As shown in FIG. 1b, upon clicking the ‘Create skill journey’ tab, they will be directed to fill in details of the skill journey like the title, author's name, and topics. In FIG. 1c, upon scrolling down from FIG. 1b, they may upload an image for the skill journey by clicking on ‘Upload image,’ ‘Select media library,’ or ‘Do it with Canva.’ The author can also add a brief description of the skill journey to help the learner identify what will be covered in the skill journey.

Below the description as shown in FIG. 1d, the author can start adding materials they want in the Skill Journey. On the left, there is a tab with all the materials in the organization Courses, Maze, SCORM Courses, and Events. The default tab is course. (The left menu resources will be not limited to 4 resources, Live assessments, coaching and other resources will be added later) The author can search and select all the course (s) to add to the skill journey at the courses tab. Once all courses have been selected, the author may proceed to click on ‘Add to Basket’ as shown in FIG. 1e

As shown in FIG. 1f, to add Maze, SCORM or Events, the author may click on the respective tabs to search and select all the course (s) to add to the skill journey at the courses tab. Once all courses have been selected, the user may proceed to click on ‘Add to Basket’. After clicking on ‘Add to Basket’, the choices selected will move and appear to ‘Basket’ on the right.

As shown in FIG. 1g, on the ‘Basket’, the author can add a score for completing each of the materials in the Skill Journey.

As shown in FIG. 1h, the user can also delete materials from the skill journey by clicking on the ‘delete icon’ at the far right. At the bottom of the basket, the author can add a pass score for the entire skill journet and add customized certificates and badges by clicking on ‘Certificate’ and ‘badge’, respectively.

On publish settings, the author can specify the Skill Journey's START DATE and EXPIRY DATE (optional) and under the privacy setings, the author specifies the audience of the Skill Journey to:

1. Organization that sets the journey to be visible to people within the selected organization(s).
2. Organizational groups that allows the journey to be visible to people within the selected organization group(s).
3. Specific users where the journey is only visible to particular users (Emails are input here).
4. Marketplace used for commercial purposes

Once the audience has been specified, the author has to read and click on ‘I AGREE TO TERMS AND CONDITIONS’ and before publishing, the author can ‘Send email notification’ to notify participants of the new skill journey.

To publish the event, the author would click on ‘Publish skill journey’

The learner is also able to make use of materials such as the live assessment feature contained in the skill journey to enhance their learnings. The learning platform's live assessment feature is a virtual tool within the learning platform that allows learners to be assessed via live video and provide immediate feedback. Live assessments allow teachers/assessors to provide learners with a question or a set of questions to be answered on live video itself. When creating the live assessment, the assessor sets the questions to be answered by the learners in advance.

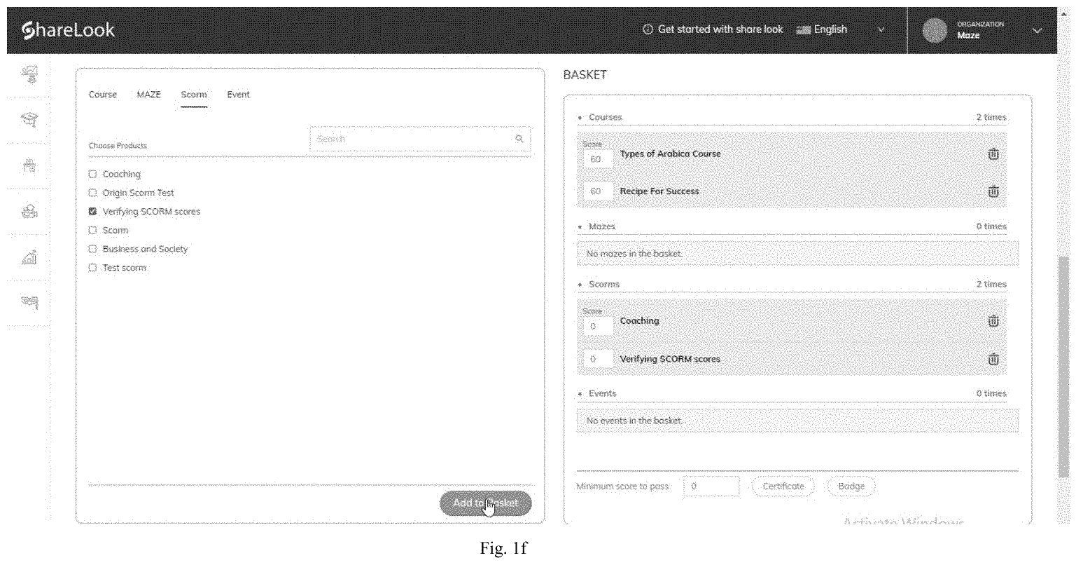

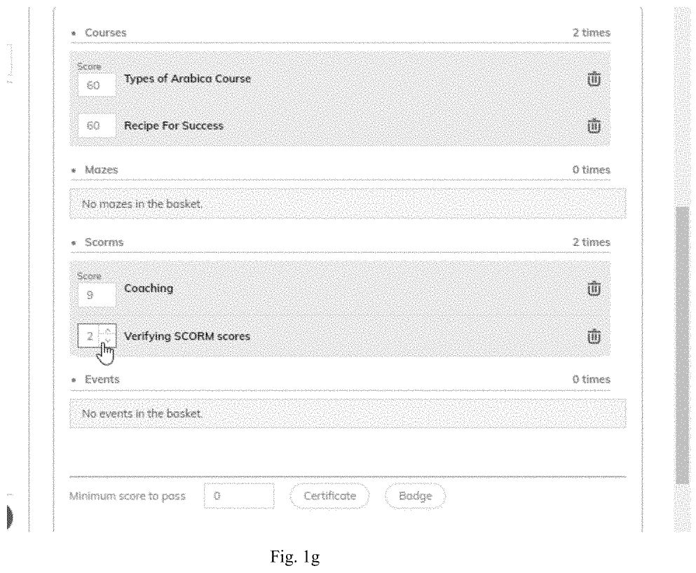

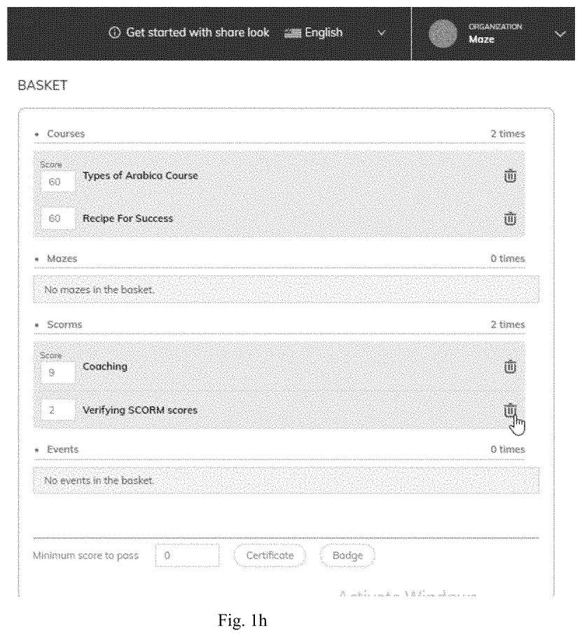

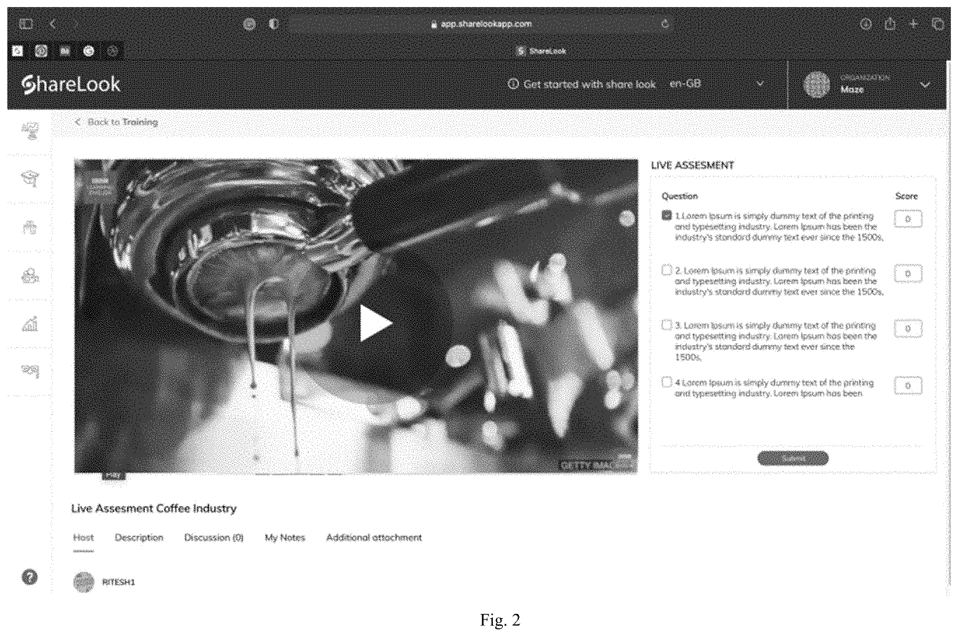

While doing a live assessment on the learning platform, and the learner begins to answer the questions verbaly or by action, the assessor will click on each question, whereby the system will capture the timestamp and tag the question to the specific frame of the live assessment video. When the learner finishes the first question and proceeds to the next, the assessor needs to check ( [symbol] ) the question to tag the question to the current video frame. FIG. 2 shows the learning platform's live assessment and the question tag to the video frame.

During the live assessment, the learner's camera will be recording the video and audio to capture the learner's response to the question. After the learner is done with the question, the assessor will assign the learner a score on each question in the live assessment and click on submit after the learner has completed all the questions. This action can also be done after the live assessment when the assessor reviews the recording session. The live assessment video of the learner and the score will be saved in the system.

During or after the live session, the assessor will also be able to provide feedback by writing comments throughout the video. The comments will be synced to the specific timestamp of the video and the learner will be able to access it conveniently by clicking on them. After the live assessment, the student can view the video with the questions and the score and be able to identify the areas for improvement.

There can also be multiple assessors during a single live assessment. In this case, each assessor can assign a score to the learner for each question and the system will compute the average score.

Live assessments are beneficial as they add an extra layer of convenience and help in reducing the cost of operations. Assessors can assess learners from wherever they are. They do not have to travel or meet up to conduct assessments. Organizations and institutions using the live assessment will be able to save on high outlay costs used to facilitate in-person interviews or assessments.

Live assessments are also advantageous as they help assessors to analyze nonverbal cues and body language. Newton (2018) notes that 15.7% of learners worldwide admit to paying someone to complete a test. In light of these revelations, live assessments could also help eliminate contractual cheating since tests are done verbally and on-camera, making it virtually impossible for learners to fake attendance.

Augmented Reality (AR) is a modern technology used for enhancing learning in higher education institutions and the corporate sector. To offer an ultra-modern learning experience, the learning platform may integrate AR into the live assessment feature.

The platform's live assessment is fitted with augmented reality to improve learning outcomes through increased engagement and interactivity, among other surprising benefits. When creating a live assessment, the assessor can upload images or animations that can be used to trigger questions for the live assessment. Through the AR feature on learning platform's live assessment, the assessor can materialize abstract concepts to help learners visualize and understand challenging subjects. This makes learning on the learning platform extraordinary and more effective.

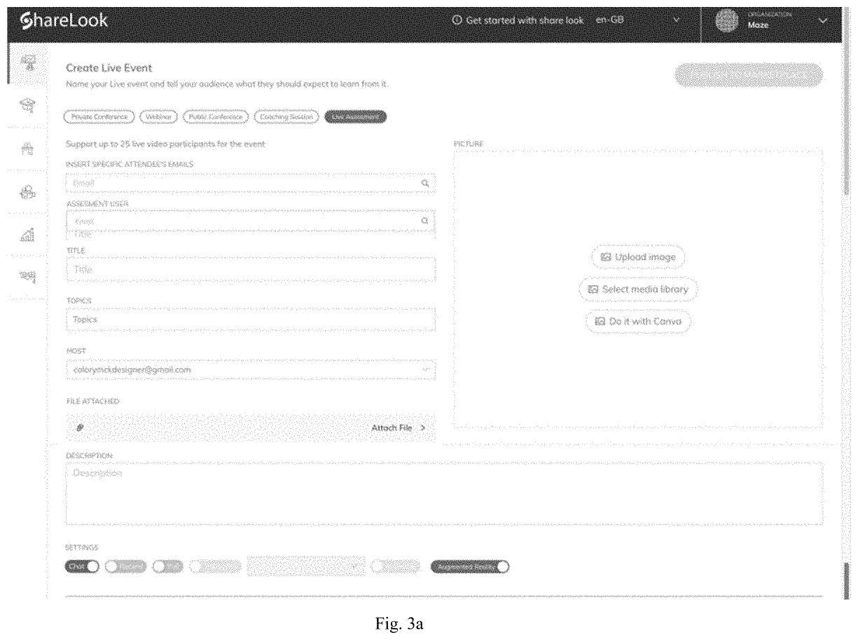

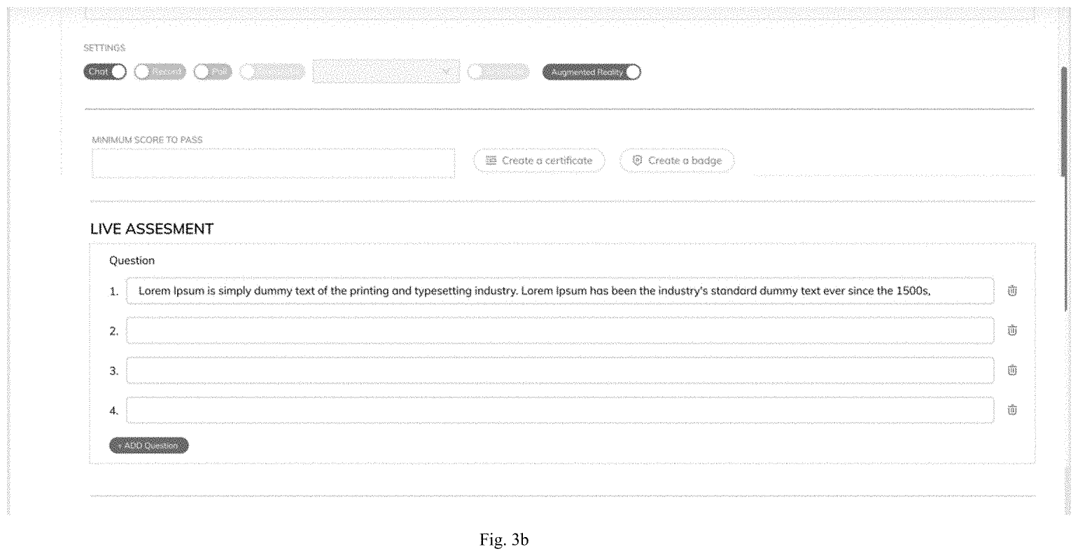

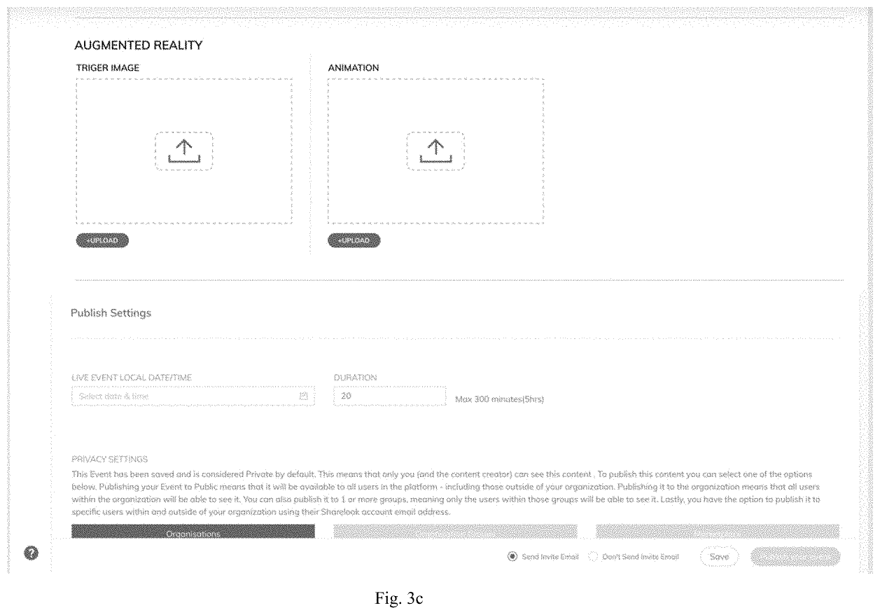

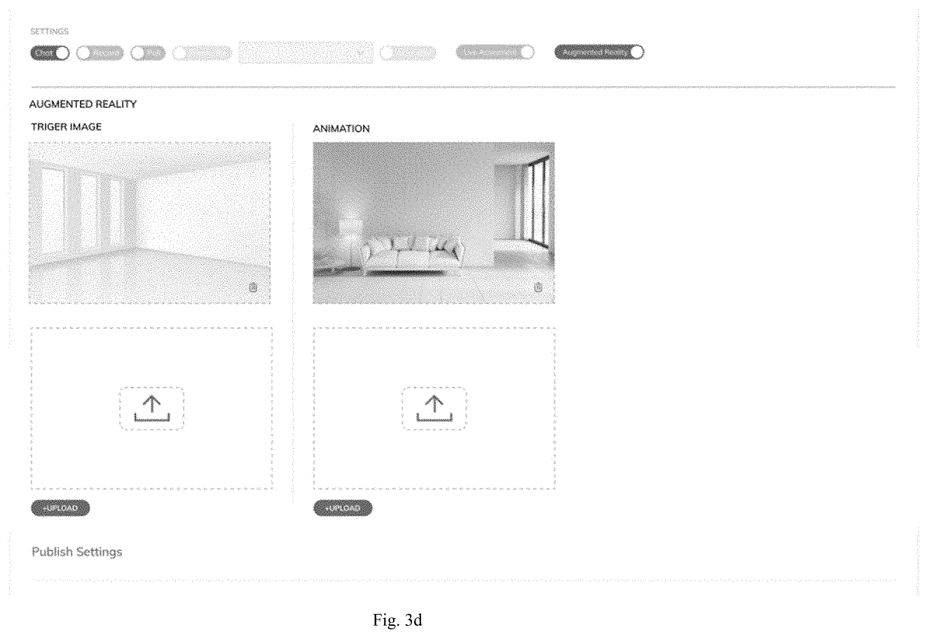

FIG. 3a-d shows various screenshots of the platform and serves as a guide to create Live Assessments. To create Live Assessments, the author may begin by clicking on ‘My Workshop’ on the left panel of the platform's homepage followed by clicking on the tab ‘Create a new live assessment’ on the top of the ‘My Workshop’ page. As shown in FIG. 3a, the author may then proceed to fill in details of the live assessment such as the attendee's email, assessment user, the title of the assessments, topics, host's email and may also upload pdf files associated with the assessment by clicking on the ‘attachment/ paper clip’ icon. The author may also upload an image for the assessment by ‘Upload image’, ‘Select media library’, or ‘Do it with Canva’. A brief description of the event can also be added.

The live assessments support features like chat, record, poll, transcriber, AI, and Augmented reality. The ‘chat’ feature is turned on by default, and it allows learners and assessors to interact via text during the assessment. ‘Record’ is used to record all the assessment interactions for archiving. When ‘Record’ is on, a host can also turn on ‘transcribe,’ which transcribes the assessment interactions in over 130 languages. Turning on ‘AI enable’ allows the assessment transcripts to be processed by the platform's AI system. When the ‘Live Assessment’ feature is turned on, the host can type or paste questions on the live assessment section. The host can add as many questions as necessary to the assessment, as seen in the screenshot below.

As shown in FIG. 3b, an artificial intelligence (AI) quiz generator will be available to help create questions for the assessment. The assessor will be able to point to a specific file and try to generate questions for the live assessment.

Turning on augmented reality (AR) allows the assessor to upload trigger images and animations that trigger AR figures used in the live assessment. The AR feature is turned on, as shown in FIG. 3c. Multiple trigger images or animations can be added in the augmented reality section of the live assessment as shown in FIG. 3d.

The next step is to select the date and time for the event and fill in the assessment's duration in minutes. The maximum duration for an event is 300 minutes (5 hours). At this point, the event is saved and considered private, only visible to the creator. Under the privacy setting, the author specifies the audience of the assessment to an organization, organizational groups, specific users, or the marketplace. Once the audience has been specified, the author would read and click on ‘I AGREE TO TERMS AND CONDITIONS.’ Before publishing, the author may select ‘Send Invite Email,’ ‘Don't Send Invite Email,’ or ‘Save’ for publishing later. To publish the event, the author will have to click on ‘Publish your event’. Following which, all personnel involved in the assessment will receive an email containing a link to join.

The present disclosure may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

1. A method for intelligent course building for an adaptive learning platform comprising:
providing a backend system, the backend system is configured to execute on a server and manage skills journey for display on a user device, the skills journey includes materials needed for a learner viewing the skills journey to learn a skill, wherein the backend system includes
a content repository module, the content repository containing existing contents for developing the skills journey, wherein the existing contents comprises learning objects which include live events comprising live broadcasts, conferences, webinars, mazes and coaching videos, and
a creation module for creating new courses, the course module is configured to build new skills journeys based on existing contents stored in the content repository as well as new content generated;
providing a frontend system, the frontend system is configured to execute on the user device, wherein the frontend system includes a user interface for the user to access various modules of the backend system; and
generating a new course by a skills journey by a builder user.
